(19) United States
(12) Patent Application Publication
(10) Pub. No.: US 2026/0316939 A1
(43) Pub. Date: Oct. 15, 2026

(54) Alignment System for an Aircraft Seat

(71) Applicant: Textron Aviation Inc., Wichita, KS (US)

(72) Inventor: Blake David Raybern, Wichita, KS (US)

(21) Appl. No.: 19/174,264

(22) Filed: Apr. 9, 2025

(51) Int. Cl. B64D 11/06

(52) U.S. Cl. CPC B64D 11/0696

(57) ABSTRACT

An aircraft seat carriage having an alignment system and a damping system. The alignment system includes spring biased arms which are configured to rotate to align rollers against an aircraft tracking rail. The arms are biased when the tracking rail is misaligned such that the rollers maintain alignment with the tracking rail. The damping system includes a pair of compression linkages configured to bias a rail engaging plate against the tracking rail when a locking pin locks the aircraft seat in position. The rail engaging plate may prevent pitching and rocking when the aircraft seat is locked.

### BACKGROUND OF THE INVENTION

### 1. Field

The disclosed embodiments relate generally to the field of aircraft interiors. More specifically, the disclosed embodiments relate to the field of aircraft seating.

### 2. Description of the Related Art

It is known for an aircraft seat to be aligned and tracked on track rails and locked in place.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to a carriage alignment system for an aircraft seat including: a rail indexing arm having an indexing roller operatively coupled to a tracking rail; a rail alignment arm having an alignment roller operatively coupled to the tracking rail and mechanically coupled to the rail indexing arm, wherein the rail indexing arm and the alignment arm are operatively coupled to an aircraft seat carriage; and a spring operatively coupled to the rail alignment arm, such that the spring biases the indexing roller towards the tracking rail and biases the alignment roller away from the tracking rail.

In some embodiments, the techniques described herein relate to an alignment system wherein the spring is disposed at a pivot point which mechanically couples the rail indexing arm and the rail alignment arm.

In some embodiments, the techniques described herein relate to an alignment system wherein the tracking rail is an I-beam including an I-shape.

In some embodiments, the techniques described herein relate to an alignment system wherein the indexing roller and the alignment roller each include a convex shape configured to allow edges of the rollers to extend over upper and lower edges of the tracking rail.

In some embodiments, the techniques described herein relate to an alignment system wherein the indexing roller and the alignment roller are configured to roll against a tracking rail edge of the tracking rail adjacent to the alignment system.

In some embodiments, the techniques described herein relate to an alignment system wherein the tracking rail includes a plurality of holes disposed along the length of a top surface of the tracking rail, wherein the holes are each configured to receive a locking pin which locks the carriage into a tracked position corresponding to a location of a respective one of the holes.

In some embodiments, the techniques described herein relate to an alignment system wherein the spring causes the indexing roller to be biased towards the tracking rail when the aircraft seat carriage is substantially aligned with the tracking rail.

In some embodiments, the techniques described herein relate to an alignment system wherein the alignment roller is mounted at an opposite side of the pivot point than the indexing roller such that pivoting at the pivot point causes the indexing arm to bias the alignment arm towards or away from the tracking rail.

In some embodiments, the techniques described herein relate to an alignment system wherein when the aircraft seat carriage is too close to the tracking rail, the tracking rail presses against the indexing roller which causes the rail indexing arm and the rail alignment arm to rotate and bias the alignment roller towards the tracking rail.

In some embodiments, the techniques described herein relate to an alignment system wherein when the aircraft seat carriage is too far from the tracking rail, the tracking rail is spaced away from the alignment roller which causes the spring to bias the indexing roller towards the tracking rail.

In some embodiments, the techniques described herein relate to an alignment system wherein rolling the indexing roller and the alignment roller against the tracking rail causes movement of the aircraft seat carriage along the tracking rail.

In some embodiments, the techniques described herein relate to a system for aligning an aircraft seat including: at least one pair of alignment subsystems, the subsystems including: an indexing roller rotatably mounted to an indexing arm, and an alignment roller rotatably mounted to an alignment arm; wherein the indexing roller and the alignment roller are configured to roll along one of a pair of tracking rails disposed within an aircraft cabin, and the indexing arm and the alignment arm are pivotally coupled together; a spring operatively coupled to the rail alignment arm such that the spring biases the indexing roller towards one of the pair of tracking rails adjacent to the alignment subsystem and biases the alignment roller away from one of the pair of tracking rails adjacent to the alignment subsystem; wherein the spring is configured to adjust when one of the pair of tracking rails presses against the indexing roller causing the alignment roller to bias further towards one of the pair of tracking rails.

In some embodiments, the techniques described herein relate to a system wherein one of the pair of alignment subsystems is disposed at a forward portion of an aircraft seat carriage and one of the pair of alignment subsystems is disposed at an aft portion of the aircraft seat carriage such that the aircraft seat carriage may be aligned with the pair of tracking rails at its forward and aft ends.

In some embodiments, the techniques described herein relate to a system wherein when the aircraft seat carriage and the pair of tracking rails are misaligned, one of the pair of tracking rails presses against at least one indexing roller, which causes the rail indexing arm to rotate which causes the alignment arm to bias the alignment roller towards the tracking rail.

In some embodiments, the techniques described herein relate to a system wherein when the aircraft seat carriage and the pair of tracking rails are misaligned, one of the pair of tracking rails is spaced away from at least one alignment roller, which causes the spring to bias the indexing arm and causes the indexing roller to move towards the tracking rail.

In some embodiments, the techniques described herein relate to a system wherein the indexing roller is rotatably mounted within a roller housing which forms an end of the indexing arm.

In some embodiments, the techniques described herein relate to a system wherein the spring is coupled to the rail alignment arm at the position where the indexing arm and the alignment arm are coupled together.

In some embodiments, the techniques described herein relate to a system wherein the indexing arm is pivotally mounted to aircraft seat structure and is configured to pivot within a groove of the aircraft seat structure.

In some embodiments, the techniques described herein relate to a system wherein the indexing roller and the alignment roller have a convex shape which allows for upper and lower edges of the rollers to extend over an edge of the tracking rail and substantially keeps the rollers engaged with the edge of the tracking rail.

In some embodiments, the techniques described herein relate to a system wherein the tracking rail is an I-beam and the indexing roller and the alignment roller roll along a tracking rail edge of the I-beam.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a perspective view of an aircraft seat carriage having a damping system and an alignment system in accordance with embodiments of the present disclosure;

FIG. 2A is a side view of the aircraft seat carriage with the damping system of FIG. 1 in an unlocked position;

FIG. 2B is a side view of the aircraft seat carriage with the damping system of FIG. 1 in a locked position;

FIG. 3 is a top view of the aircraft seat carriage with the damping system of FIG. 1;

FIG. 4 is a perspective view of the aircraft seat carriage with the damping system of FIG. 1;

FIG. 5 is a close-up perspective view of the damping system of FIG. 1 in a locked position and engaged with a tracking rail;

FIG. 6 is a perspective view of the alignment system of FIG. 1;

FIG. 7 is another perspective view of the alignment system of FIG. 1;

FIG. 8 is a top close-up view of the alignment system of FIG. 1;

FIG. 9 is a top view of the alignment system of FIG. 1 with the aircraft seat carriage and the tracking rail substantially in alignment;

FIG. 10 is a top view of the alignment system of FIG. 1 with the aircraft seat carriage and the tracking rail misaligned; and

FIG. 11 is a top view of the alignment system of FIG. 1 with the tracking rail and the aircraft seat carriage misaligned.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

### Overview

Embodiments disclosed herein provide a system and a method for an aircraft seat carriage system. Current aircraft seat tracking systems have limited free play and functionality which may result in low customer satisfaction. Some limitations may arise from inconsistent tracking rail installation on aircraft. For instance, track rails may be installed with inconsistent spacing and misalignment between the rails. Due to this inconsistency, current aircraft seat tracking systems are configured to have intentional free play to prevent the carriage from colliding with the track rails when being tracked, and when the seat is in a locked position, which results in the seat being able to pitch and rock. This free play may result in customer dissatisfaction due to the possible resistance experienced by a user when tracking the aircraft seat and possible pitching and rocking of the aircraft seat when it is in a locked position. A system is needed which aligns the aircraft seat carriage when it is being tracked and reduces the amount of rocking and pitching when the seat is in a locked position despite track rails potentially being installed with inconsistent spacing and misalignment.

Embodiments disclosed herein provide a system for an aircraft seat carriage. In embodiments, the system includes a damping system and an alignment system which may substantially decrease the amount of rocking and pitching when the aircraft seat is locked on a tracking rail and may align the aircraft seat when the seat is being tracked on the tracking rail. In embodiments, the damping system and alignment system are implemented onto an aircraft carriage structure which supports an aircraft seat. .

### Damping System

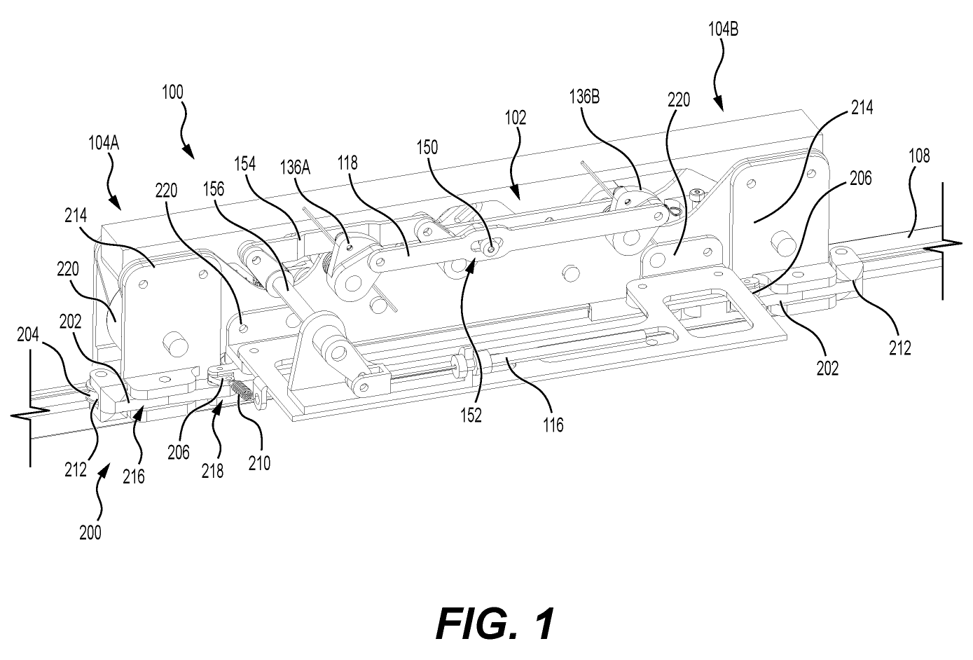

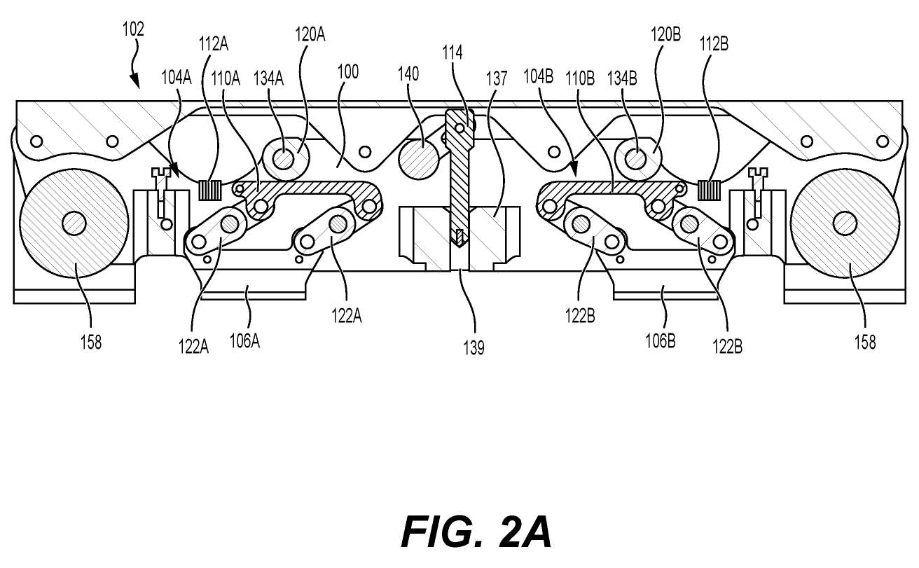

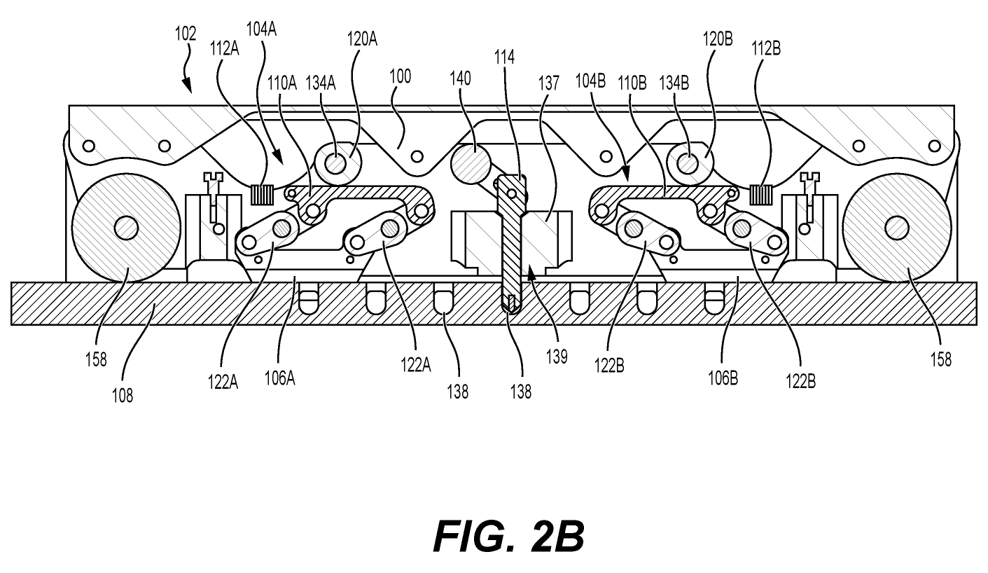

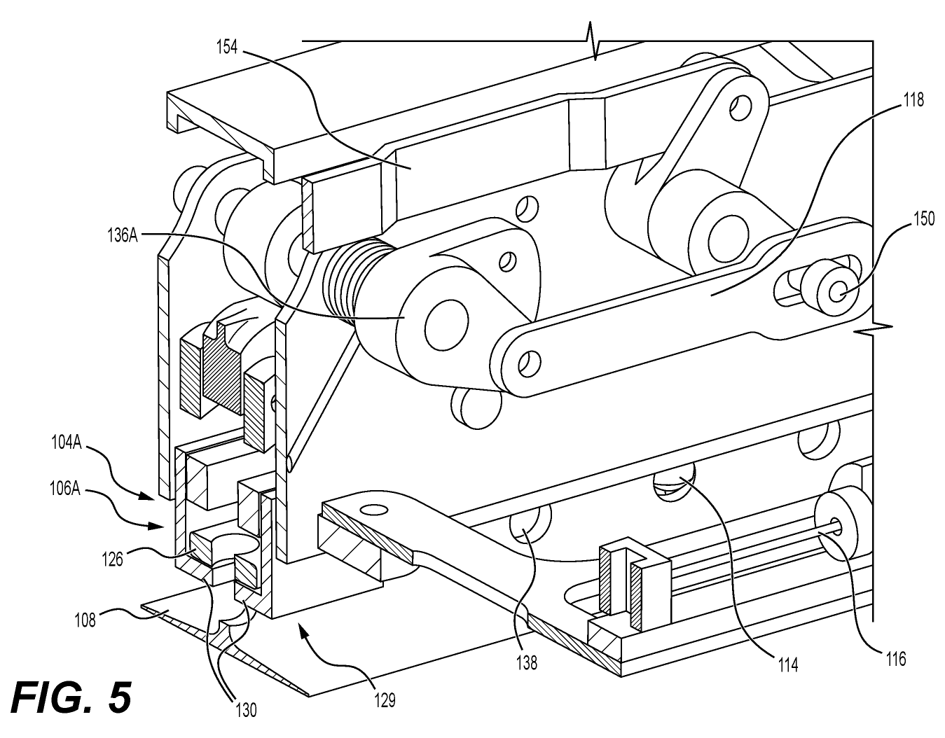

With reference to FIGS. 1-11 an aircraft seat carriage 100 having a damping system 102 is shown and described. The damping system 102 includes a pair of compression linkages 104A and 104B configured to press a pair of rail engaging plates 106A and 106B against the tracking rail 108 for an aircraft seat carriage 100. A locking pin 114 is operatively coupled to a seat control cable 116 such that when the seat control cable is relaxed the locking pin 114 engages with the tracking rail 108 and locks the aircraft seat carriage 100 in position. When the locking pin 114 engages with the tracking rail 108, a compression linkage control arm 118 operatively coupled to a pair of compression cams 120A and 120B bias the compression cams against the compression linkages 104A and 104B such that the rail engaging plates 106A and 106B of the linkage pair each engage with the tracking rail 108 which substantially dampens the free play of the aircraft seat carriage 100 when it is locked in position With reference to FIG. 1, showing a front perspective view of the damping system 102 and FIGS. 2A and 2B showing a cross sectional side view of the damping system 102 with portions of structure of the aircraft seat carriage 100 removed, the damping system 102 comprises a pair of compression linkages 104A and 104B each having a rail engaging plate 106A and 106B for pressing against a tracking rail 108. The compression linkages 104A and 104B each comprise a compression plate 110A and 110B mechanically coupled to return springs 112A and 112B. A locking pin 114 is operatively coupled to a seat control cable 116. The locking pin 114 is configured to engage with the tracking rail 108 to substantially lock the aircraft seat carriage 100 in a fixed position along the tracking rail 108. The locking pin 114 becomes engaged or disengaged with the tracking rail 108 when the seat control cable 116 is relaxed or tensioned, respectively. A compression linkage control arm 118 is operatively coupled to the locking pin 114 and a pair of compression cams 120A and 120B. The compression cams 120A and 120B are configured to bias the compression plates 110A and 110B away from their respective return springs 112A and 112B when the locking pin 114 is engaged with tracking rail 108 (see FIG. 2B). The pressing of the rail engaging plates 106A and 106B against tracking rail 108 (see FIG. 5) causes damping of the aircraft seat and causes the free play in the aircraft seat carriage 100 to be reduced.

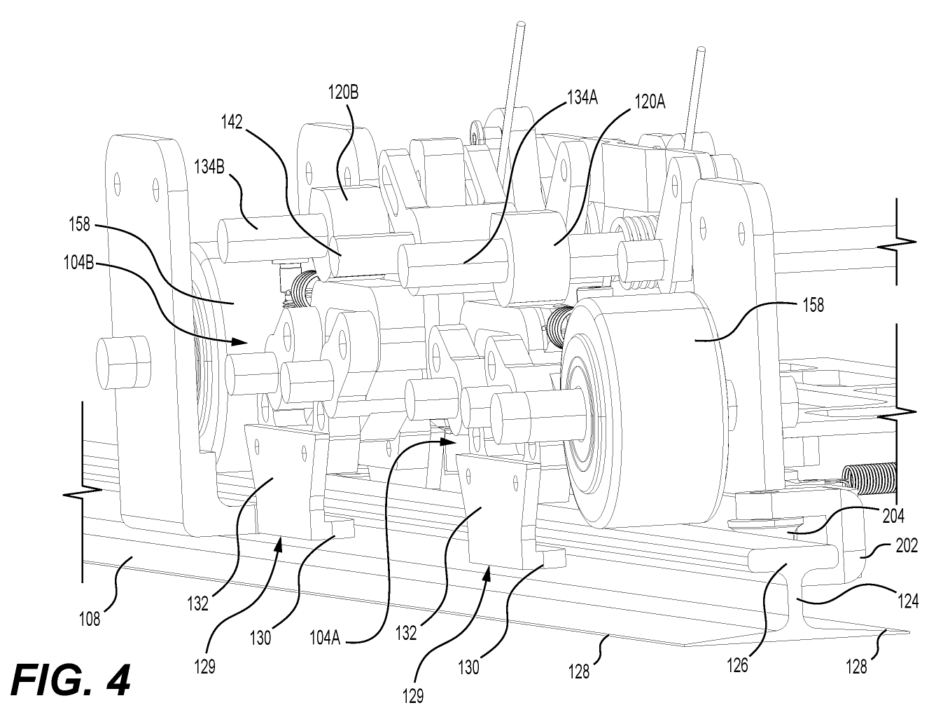

With reference to FIGS. 2A and 2B, the compression linkages 104A and 104B are shown. In embodiments, the compression linkages 104A and 104B are four-bar linkages and include the compression plates 110A and 110B, a pair of link arms 122A and 122B, and the rail engaging plates 106A and 106B. In embodiments, the compression linkage 104A is positioned forward and the compression linkage 104B is positioned aft of the linkage 104A. In embodiments, the positioning of the compression linkages 104A and 104B allow for compression to be applied to forward and aft portions of the tracking rail 108. The damping system 102 allows for the compressive forces to be applied simultaneously to different portions of the tracking rail 108 such that pitching and rocking of the aircraft seat carriage 100 is substantially prevented. The pair of compression linkages 104A and 104B may be advantageous when compared to a single linkage applying compressive forces at the center of the aircraft seat carriage 100 since the dual linkages 104A and 104B apply force at opposite ends of the aircraft seat carriage 100 instead of at a center of the carriage as may be done with a single linkage. The link arms 122A and 122B are rotatably connected at opposing ends of the rail engaging plates 106A and 106B and are rotatably connected at opposing ends of the compression plates 110A and 110B. The link arms 122A and 122B are rotatably mounted at their midpoints to structure of the aircraft seat carriage 100 which acts as a static reference frame and allows for the compression linkages 104A and 104B to move and rotate relative to the aircraft seat carriage 100. In embodiments, when biased and actuated, the rail engaging plates 106A and 106B and the compression plates 110A and 110B may maintain a substantially horizontal orientation that is parallel to the tracking rail 108 due to the pivotal connection and orientation of the link arms 122A and 122B. In embodiments, the return springs 112A and 112B are mounted at ends of the compression plates 110A and 110B and to the structure of the aircraft seat carriage 100. In embodiments, the springs 112A and 112B hold the compression plates 110A and 110B in a position such that the rail engaging plates 106A and 106B are spaced away from the tracking rail 108 (see FIG. 4). In embodiments, the rail engaging plates 106A and 106B are spaced away below the tracking rail 108 such that a gap exists directly beneath the tracking rail 108 and each rail engaging plate 106A and 106B.

In embodiments, with reference to FIG. 4, the tracking rail 108 may be an I-beam having an I-shape with a vertical portion 124 perpendicular to a horizontal portion 126. In embodiments, a rail base 128 may be substantially parallel to the horizontal portion 126 on an opposing end of the vertical portion 124. The rail base 128 may be configured to fasten to an aircraft fuselage structure. The horizontal portion 126 extends across the vertical portion 124 to form flanges which engage with the rail engaging plates 106A and 106B. The rail engaging plates 106A and 106B each comprise an L-shaped bracket 129 comprising a horizontal portion 130 and a vertical portion 132 perpendicular to the horizontal portion 130. In embodiments, the horizontal portion 130 of the rail engaging plates 106A and 106B is substantially parallel to the horizontal portion 126 of the tracking rail 108 and is positioned to extend over the lip created by the I-shape of the tracking rail 108. In this way, when the rail engaging plates 106A and 106B are actuated upwards towards the tracking rail 108, as shown in FIG. 5, the horizontal portion 130 of the rail engaging plates 106A and 106B engages with the tracking rail 108 and presses against the horizontal portion 126 of the tracking rail 108. This engagement substantially locks the rail engaging plates 106A and 106B into place on the tracking rail 108 to reduce pitching and rocking.

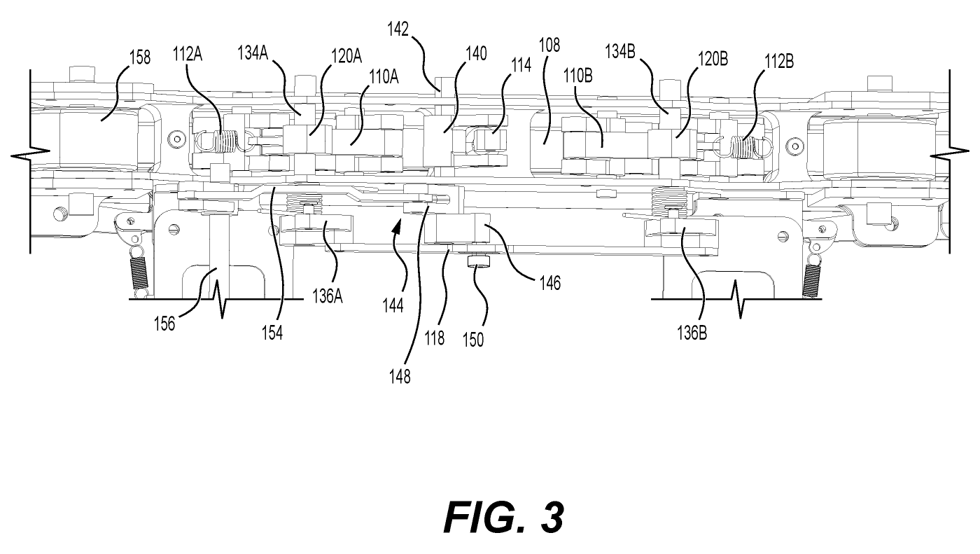

In embodiments, biasing the compression plates 110A and 110B in a downward direction towards tracking rail 108 rotates the link arms 122A and 122B causing the rail engaging plates 106A and 106B to be actuated upwards towards the tracking rail 108, such that the L-shaped bracket 129 of the rail engaging plates 106A and 106B engages with the lip of the tracking rail 108. With reference to FIGS. 3 and 4, compression cams 120A and 120B are rotatably mounted above the compression plates 110A and 110B and are configured to rotate about a central axis created by cam pivot tubes 134A and 134B which rotatably connect to each of the compression cams 120A and 120B. The compression cams 120A and 120B comprise an oblong shape such that each cam has portions with a different radius of curvature. The cams 120A and 120B are positioned directly above the compression plates 110A and 110B such that the outer edge of each cams 120A,120B is directly against and contacts the upper surface of each compression plate 110A, 110B, respectively. When the compression cams 120A and 120B are rotated about their axis, the oblong portions (e.g., portions with a different radius of curvature) of the cams press against the compression plates 110A and 110B and bias the plates 110A and 110B downwards. This causes a rotation of the link arms 122A and 122B opposite to the pull of the springs 112A and 112B. In embodiments, the springs 112A and 112B are configured to stretch when the oblong portions of the cams 120A and 120B push the compression plates 110A and 110B downwards, the stretching being due to the rotation of the compression linkages 104A and 104B in an opposite direction than that of the pull of the springs 112A and 112B. In embodiments, with reference to FIGS. 2A and 2B, the spring 112A is positioned on the left-hand side of the compression plate 110A which causes the linkage 104A to rotate counterclockwise to resist motion when the cam 120A biases the compression plate 110A downwards. The spring 112B is positioned on the right-hand side of the compression plate 110B which causes the linkage 104B to rotate clockwise to resist motion when the cam 120B biases the compression plate 110B downwards. In this way, the rail engaging plates 106A and 106B are actuated upwards and pressed against the tracking rail 108 except when disengaged via seat control cable 116 and locking pin 114.

With reference to FIGS. 3 and 4, the compression cams 120A and 120B are each mechanically coupled to the cam pivot tubes 134A and 134B. The cam pivot tubes 134A and 134B mechanically couple to the cams 120A and 120B on one end and on their other ends are mechanically coupled to cam bell cranks 136A and 136B. The cam bell cranks 136A and 136B are mounted to compression linkage control arm 118. The cam bell cranks 136A and 136B are rotatably mounted to the compression linkage control arm 118 on opposing ends. When the control arm 118 is deflected or biased, the cam bell cranks 136A and 136B rotate together which causes the cams 120A and 120B to rotate in unison. The mechanical connection of the control arm 118 between the cams 120A and 120B allows for the cams to rotate together, thus allowing the compression linkages 104A and 104B to rotate together causing the rail engaging plates 106A and 106B to be pressed against the tracking rail 108 at substantially the same time. In embodiments, the compression linkage control arm 118 may be biased in substantially upward and downward directions which results in either a clockwise or counterclockwise rotation of the bell cranks 136A and 136B. In embodiments, when the control arm 118 is biased downwards the bell cranks 136A and 136B rotate clockwise, causing the coupled pivot tubes 134A and 134B to rotate, which cause the cams 120A and 120B to rotate.

In embodiments, with reference to FIGS. 2A and 2B, actuation of the control arm 118 is controlled by actuation of the locking pin 114. In embodiments, the locking pin 114 is configured to be actuated upwards and biased downwards to engage and disengage with the tracking rail 108. In embodiments, a bracket 137 includes an aperture 139 which guides the locking pin 114 when it is actuated upwards and biased downwards. When the locking pin 114 is biased downward and extended out of the aperture 139, the pin may engage with the tracking rail 108. For instance, when the locking pin 114 is biased downwards, an end of the pin passes through the aperture in bracket 137 and inserts into a hole 138 (FIG. 2B) disposed on an upper facing surface of the horizontal portion 126 of the tracking rail 108. In embodiments, a plurality of holes 138 may be disposed at spaced increments along the upper facing surface of the tracking rail 108 such that the aircraft seat carriage 100 may be tracked and the locking pin 114 inserted into any one of the holes 138 corresponding to different tracked positions of the aircraft seat carriage 100. The holes 138 may be ovular or oblong to allow for some misalignment of the locking pin 114 when being inserted into one of the holes 138. In embodiments, the locking pin 114 is mounted to an extension arm 140 which is mechanically coupled to a locking pin pivot tube 142. The locking pin pivot tube 142 on one end is mechanically coupled to the extension arm 140 and on its other end is mechanically coupled to a locking pin control arm 144 (see FIG. 3). The locking pin control arm 144 includes a bolt extending arm 146 and a seat control linkage arm 148. In embodiments, the bolt extending arm 146 attaches to a bolt 150 with a head that passes through a slot 152 formed into the compression linkage control arm 118. The slot 152 allows for the bolt 150 to slide freely in a horizontal direction while maintaining a pivotal connection to the control arm 118. In embodiments, when the seat control linkage arm 148 is biased or actuated, the locking pin pivot tube 142 is rotated causing the locking pin 114 to be biased downwards, and the bolt 150 may slide within the slot 152 and bias the compression linkage control arm 118 downward. When the locking pin pivot tube 142 is rotated in an opposite direction by the seat control linkage arm 148, the locking pin 114 is actuated upwards, and the bolt 150 may slide within the slot 152 and actuate the compression linkage control arm 118 upwards. The seat control linkage arm 148 of the locking pin control arm 144 substantially initiates the rotation of the locking pin pivot tube 142 and therefore the biasing or actuation of the locking pin 114 and compression linkage control arm 118. Due to the connection between the locking pin 114 and the compression linkage control arm 118, the control arm 118 is only able to be biased or actuated when the locking pin 114 is engaged or disengaged with the tracking rail 108 which is advantageous for the tracking of the aircraft seat carriage 100 along the tracking rail 108.

With reference to FIGS. 1 and 3, the seat control linkage arm 148 is mechanically coupled to a control cable linkage arm 154. The control cable linkage arm 154, on one end, is pivotally mounted to the seat control linkage arm 148 of locking pin control arm 144, and on its other end, is mechanically coupled to a seat control pivot tube 156. The seat control pivot tube 156 is mechanically coupled to the seat control cable 116. In embodiments, tensioning of the seat control cable 116 rotates the seat control pivot tube 156 which biases the control cable linkage arm 154 and in turn biases the seat control linkage arm 148 of locking pin control arm 144. In some embodiments, the seat control cable 116 may be mechanically coupled to a user accessible handle (not shown) which corresponds to seat position control of the aircraft seat carriage 100. When the handle is released, tension may be removed from the seat control cable 116 which rotates the seat control pivot tube 156. When the seat control pivot tube 156 is rotated the control cable linkage arm 154 is biased in a horizontal direction which causes the seat control linkage arm 148 to be biased, and in turn, rotates the locking pin pivot tube 142 and simultaneously, causes the locking pin 114 to insert into one of the holes 138 in tracking rail 108 and biases the compression linkage control arm 118 downward.

In operation, the damping system 102 may be engaged when the aircraft seat carriage 100 is locked onto the tracking rail 108 as shown in FIG. 5. In some embodiments, a user may access a handle which corresponds to seat position control for the aircraft seat carriage 100. In operation, starting from a locked position, depressing the handle causes the aircraft seat carriage 100 to be in an unlocked position, which is a position in which the locking pin 114 is not engaged with the tracking rail 108. In embodiments, a handle depression corresponds to tension being added to the seat control cable 116. Tension in the seat control cable 116 causes the seat control pivot tube 156 to rotate which actuates the control cable linkage arm 154. In embodiments, rotation of the seat control pivot tube 156 causes the control cable linkage arm 154 to be actuated horizontally and parallel to the tracking rail 108. The actuation of the control cable linkage arm 154 causes an actuation or rotation of the seat control linkage arm 148 of the locking pin control arm 144. Rotation of the locking pin control arm 144 causes the locking pin pivot tube 142 to rotate which actuates the locking pin 114 upwards and out of the hole 138 in the tracking rail 108. Simultaneously, the bolt 150 causes the compression linkage control arm 118 to be actuated upwards which rotates the cam pivot tubes 134A and 134B. Simultaneous rotation of both cam pivot tubes 134A and 134B causes the cams 120A and 120B to rotate such that the oblong portion of each cam rotates away from the compression plates 110A and 110B. The rotation of the oblong portion of the cams 120A and 120B away from the compression plates 110A and 110B allows the return springs 112A and 112B to pull the compression plates 110A and 110B upwards. The upward actuation of the compression plates 110A and 110B causes the link arms 122A and 122B to rotate and move the rail engaging plates 106A and 106B away from the horizontal flange 126 of tracking rail 108. When the rail engaging plates 106A and 106B are actuated downwards and away from the tracking rail 108, the damping system 102 is disengaged which allows the aircraft seat carriage 100 to track on the tracking rail 108 using the roller wheels 158. The roller wheels 158 are configured to roll along the upper surface of the horizontal portion 126 of the tracking rail 108 and may include heavy duty ball bearings press fit into a milled wheel housing. In some embodiments, the ball bearings may support static loading of up to approximately eight hundred pounds, and dynamic loading of approximately one thousand eight hundred and fifty pounds. In some embodiments the diameter of the roller wheels 158 may be approximately 1.99 inches.

In operation, starting from an unlocked position, shown in FIG. 4, when the seat control cable 116 is tensioned and the locking pin 114 is disengaged from the tracking rail 108, the aircraft seat carriage 100 is tracked to substantially align the locking pin 114 with a hole 138 disposed on the tracking rail 108. The aircraft seat carriage 100 may then be moved along the tracking rail 108 to different positions corresponding to the holes 138 disposed in increments along the tracking rail 108. When the handle is released, the seat control cable 116 is relaxed which causes the seat control pivot tube 156 to rotate. Rotation of the seat control pivot tube 156 biases the control cable linkage arm 154 which causes rotation of the locking pin control arm 144. Rotation of the locking pin control arm 144 causes simultaneous downward biasing of both the compression linkage control arm 118 and locking pin 114. The locking pin 114 may include a pointed end which allows for slight misalignment when being biased downwards into one of the oblong holes 138. The compression linkage control arm 118 causes the cam pivot tubes 134A and 134B to rotate the cams 120A and 120B such that the oblong portion of the cam rotates towards the compression plates 110A and 110B. The oblong portion of the cams 120A and 120B biases the compression plates 110A and 110B downwards and stretches the return springs 112A and 112B. The downward biasing of the compression plates 110A and 110B causes the link arms 122A and 122B to rotate causing the rail engaging plates 106A and 106B to be biased upwards towards the tracking rail 108. The rail engaging plates 106A and 106B then press against the tracking rail 108. In some embodiments, the pressing of the rail engaging plates 106A and 106B with the tracking rail 108 may substantially prevent free play and dampen the ability of the aircraft seat carriage 100 to pitch.

### Alignment System

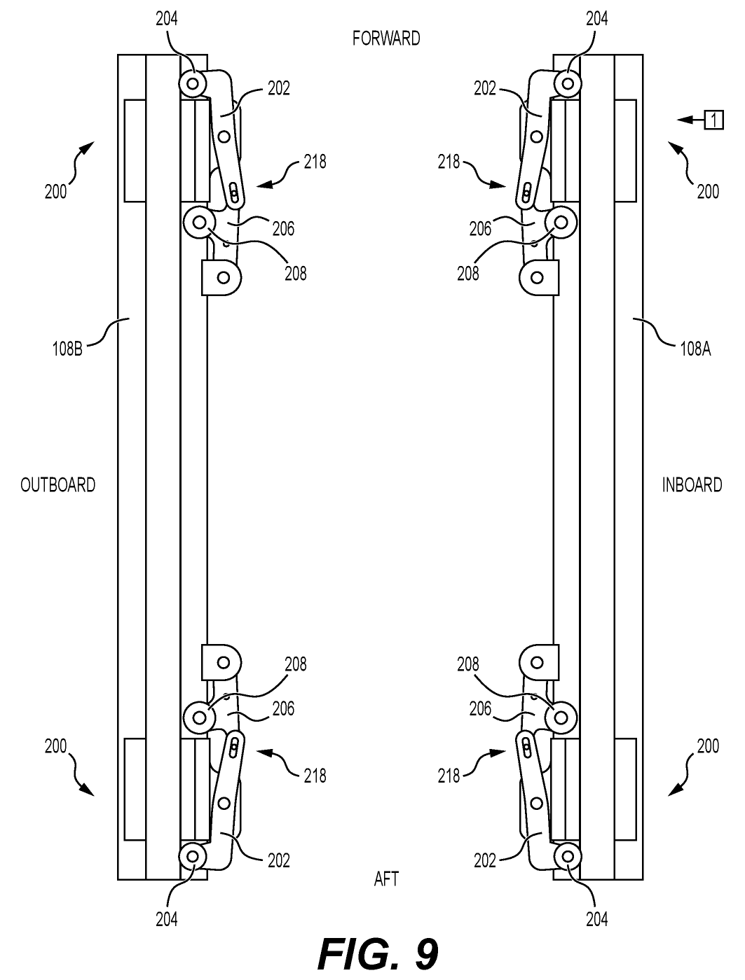

With reference to FIGS. 1-11, an alignment system 200 is shown and described. The alignment system 200 includes rollers 204 and 208 mounted onto indexing and alignment arms 202 and 206. The arms are configured to pivot and align the rollers such that the rollers engage with a tracking rail 108. A spring 210 operatively coupled to the alignment arm 206 may bias the alignment arm 206 and the indexing arm 202 in response to changes in the alignment and orientation of the tracking rail 108 to maintain alignment of the rollers 204 and 208 with the tracking rail. In embodiments, the alignment system 200 is configured with the aircraft seat carriage 100 and substantially aligns the carriage 100 with an inboard tracking rail 108A and an outboard tracking rail 108B. The alignment system 200 may be configured to engage with the tracking rails 108A and 108B at a forward and aft portion of the aircraft seat carriage 100. In this way, the aircraft seat carriage 100 may be aligned with the tracking rails 108A and 108B at forward and aft ends which may substantially prevent binding up. It may be advantageous to have a pair of alignment systems 200 (as shown in embodiments in FIGS. 9-11) configured at each end of the aircraft seat carriage 100 versus a single alignment system configured with the aircraft seat carriage 100 so that each end of the aircraft seat carriage 100 may be aligned with separate portions of the tracking rail 108 which may prevent misalignment and binding up. Directional references forward, aft, inboard, and outboard are shown in FIGS. 9-11. In embodiments, the inboard tracking rail 108A is shown on a right-hand side of the figures and the outboard tracking rail is shown on a left-hand side of the figures. It should be recognized that directional references herein are directed towards an aircraft seat carriage 100 positioned on a left-hand side of an aircraft cabin; however, an aircraft seat carriage 100 on a right-hand side of the aircraft cabin may be implemented in accordance with embodiments of this disclosure such that directional references and features disclosed are substantially mirrored.

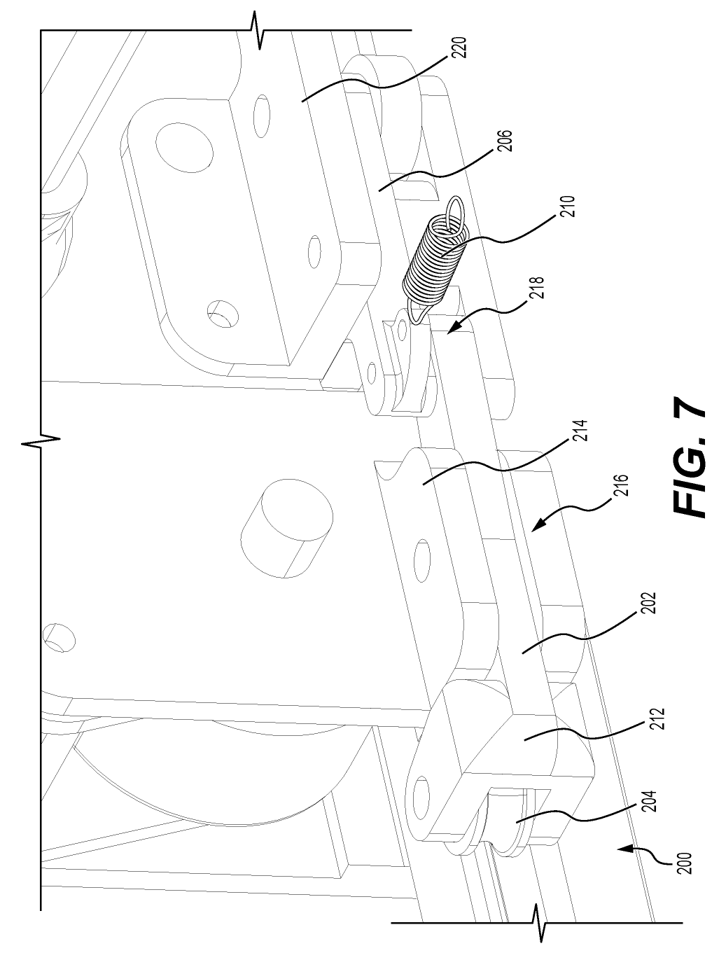

With reference to FIGS. 1 and 6-11 the alignment system 200 comprises a rail indexing arm 202 having an indexing roller 204 and a rail alignment arm 206 having an alignment roller 208. A spring 210 is operatively coupled to the rail alignment arm 206 and biases the rail alignment arm 206 and rail indexing arm 202 such that the indexing roller 204 and alignment roller 208 align with the tracking rail 108. In embodiments, the rail indexing arm 202 at one end includes a roller housing 212 which houses the indexing roller 204. The roller housing 212 allows for the indexing roller 204 to rotate relative to the rail indexing arm 202. At its other end, the rail indexing arm 202 is pivotally coupled to the rail alignment arm 206. The rail indexing arm 202 is pivotally coupled at its midpoint to a bracket 214 (FIG. 7) which is part of the structure of the aircraft seat carriage 100. In some embodiments, the rail indexing arm 202 inserts into a groove 216 formed through the bracket 214 which allows the rail indexing arm 202 to pivot in a single plane. The rail indexing arm 202 and rail alignment arm 206 are pivotally coupled together at their ends such that they have a common pivot point 218. The rail alignment arm 206 is disposed against bracket structure 220 (FIG. 7) of the aircraft seat carriage 100. The bracket structure 220 substantially allows for the rail alignment arm 206 to pivot in a single plane aligned with the pivot plane of the rail indexing arm 202. The rail alignment arm 206 is pivotally coupled to the bracket structure 220 at an end opposite of the end pivotally coupled to the rail indexing arm 202. The rail alignment arm 206 includes a roller extension 209 having the alignment roller 208. The alignment roller 208 is configured to rotate relative to the rail alignment arm 206. In embodiments, the alignment roller 208 is positioned nearer to the pivot point 218 and at an opposite side of the pivot point 218 than the indexing roller 204. In embodiments, the indexing roller 204 and alignment roller 208 are configured to roll along a tracking rail edge of the tracking rail 108 adjacent to the alignment system 200. The spring 210 is attached to the rail alignment arm 206 at the pivot point 218 of the rail indexing arm 202 and rail alignment arm 206. The spring 210 is configured to adjust (e.g., stretch) such that both the indexing roller 204 and alignment roller 208 may respond to the orientation and position of the tracking rails 108A/108B and substantially the indexing roller 204 may maintain contact with the tracking rails 108A/108B. In embodiments, the spring 210 substantially allows for the indexing roller 204 and alignment roller 208 to be biased and adjust to misalignments in the tracking rails 108A/108B.

The spring 210 is configured to allow the indexing roller 204 and alignment roller 208 to be biased in response to misalignments between the tracking rails 108A and 108B and aircraft seat carriage 100. In some embodiments, the tracking rails 108A and 108B may have a misaligned orientation due to either of the tracking rails 108A/108B being installed unparallel to one another in the aircraft cabin which causes the aircraft seat carriage 100 to be misaligned with the rails. In some embodiments, the aircraft seat carriage 100 may be positioned too close or too far from the pair of rails 108A/108B. In embodiments, the pivotal connection of the rail indexing arm 202 and rail alignment arm 206 and the adjustability provided by spring 210 allows for the indexing roller 204 and alignment roller 208 to adjust to misalignments between the tracking rails 108A/108B and aircraft seat carriage 100. In this way, motion of the aircraft seat carriage 100 along the tracking rails 108A/108B may be substantially smoother and much less likely to bind up.

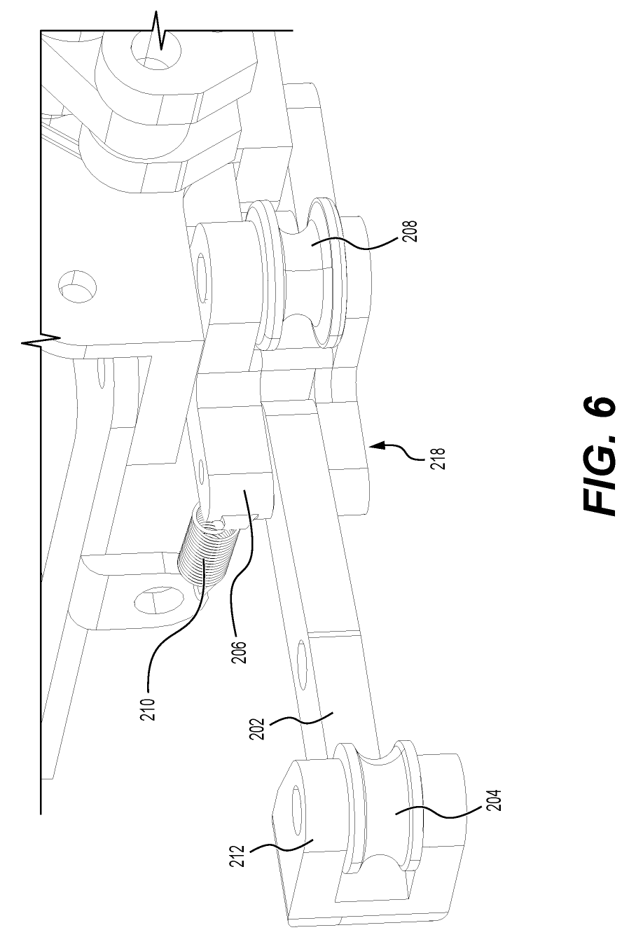

With reference to FIG. 6, the indexing roller 204 and alignment roller 208 are convex shaped rollers configured to interact with the flanges of the I-shaped tracking rail 108. The convex roller shape allows edges of the roller to extend over a tracking rail edge of the tracking rails 108A/108B. This substantially provides a degree of damping as the edges of the indexing roller 204 and alignment roller 208 prevent the aircraft seat carriage 100 from moving upwards and downwards. In some embodiments, the convex shape of indexing roller 204 and alignment roller 208 may reduce the friction and resistance of the aircraft seat carriage 100 against the tracking rail 108 when moving along the tracking rails 108A/108B.

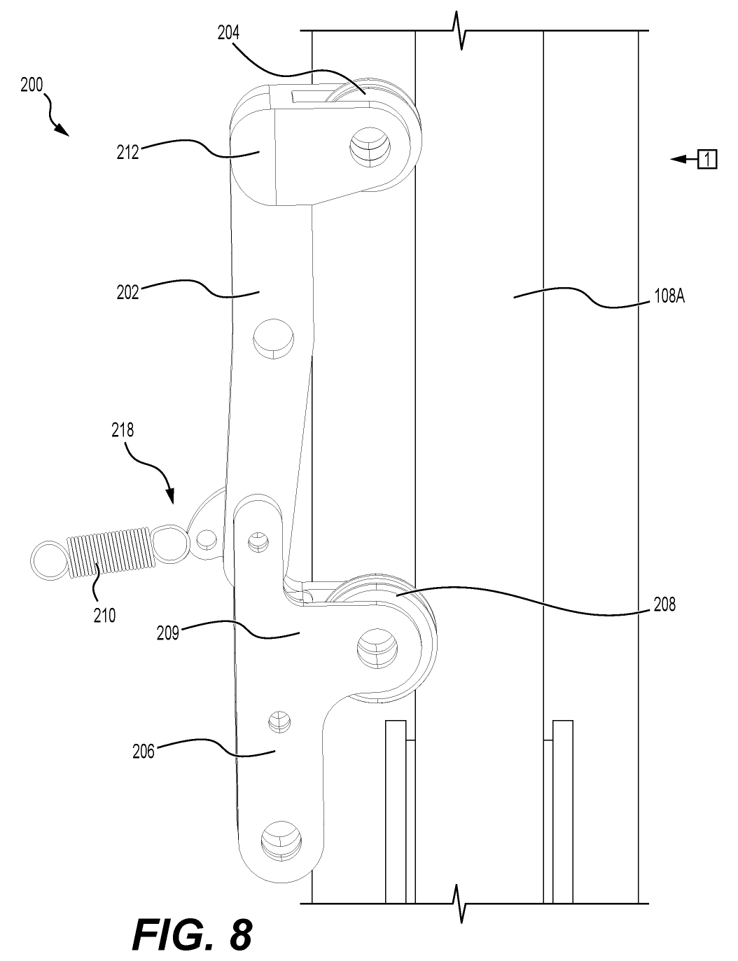

In embodiments, with reference to FIGS. 8 and 9, the inboard tracking rail 108A is shown with the indexing roller 204 and alignment roller 208 contacting the tracking rail edge of the tracking rail 108A (e.g., the face which faces towards the outboard tracking rail 108B). The tension of spring 210 is directed substantially away from the inboard rail 108A, which causes the rail indexing arm 202 to rotate clockwise (relative to FIG. 8) and bias the indexing roller 204 towards the inboard tracking rail 108A. The spring 210 tension causes the rail alignment arm 206 to rotate counterclockwise and bias the alignment roller 208 away from the inboard tracking rail 108A. In this way, both the indexing roller 204 and alignment roller 208 may be aligned with the tracking rail 108. The position of the pivot point 218 causes the rail indexing arm 202 and rail alignment arm 206 to rotate in opposite directions when the spring 210 is tensions and relaxes which allows for both the rail indexing arm 202 and indexing roller 204 to be aligned with the tracking rail 108.

With reference to FIG. 9, the aircraft seat carriage 100 is substantially aligned with the tracking rails 108A and 108B. In the embodiment shown in FIG. 9, the aircraft seat carriage 100 substantially centered between the rails 108A/108B such that the distance between the carriage and the rails is substantially equal on inboard and outboard sides. In embodiments, when the carriage 100 and inboard tracking rail 108A/108B are aligned, as shown in FIG. 9, the aircraft seat carriage 100 is aligned with the tracking rails 108A/108B on forward, aft, inboard, and outboard sides. In embodiments, the alignment system 200 substantially allows the aircraft seat carriage 100 to move along the rails 108A/108B. When the aircraft seat carriage 100 is aligned with the rails 108A/108B, the aircraft seat carriage 100 substantially oscillates freely between the rails. In embodiments, the indexing roller 204 tracks along the rail tracking edge of the rails 108A/108B and is biased by the spring 210 towards a rail and presses the indexing roller 204 against the tracking rail edge. In embodiments, the spring 210 biases the rail alignment arm 206 and alignment roller 208 away from the tracking rail 108 such that the alignment roller 208 is spaced away from the rail. In this way, the indexing roller 204 may substantially maintain contact with the tracking rail edge of tracking rail 108 while the alignment roller 208 is spaced away. The alignment roller 208 contacts the rails 108A/108B when the rails and the carriage are misaligned. In this way, the alignment between the aircraft seat carriage 100 and the tracking rails 108A/108B acts as an input for whether or not the alignment roller 208 is pressed against or spaced away from a respective rail. This substantially may prevent the aircraft seat carriage 100 from colliding with the tracking rail 108. This is advantageous because the aircraft seat carriage 100 may track more smoothly on the tracking rails 108A/108B and may allow for seat movement along the tracking rails 108A/108B when there is misalignment between the aircraft seat carriage 100 and the rails 108A/108B.

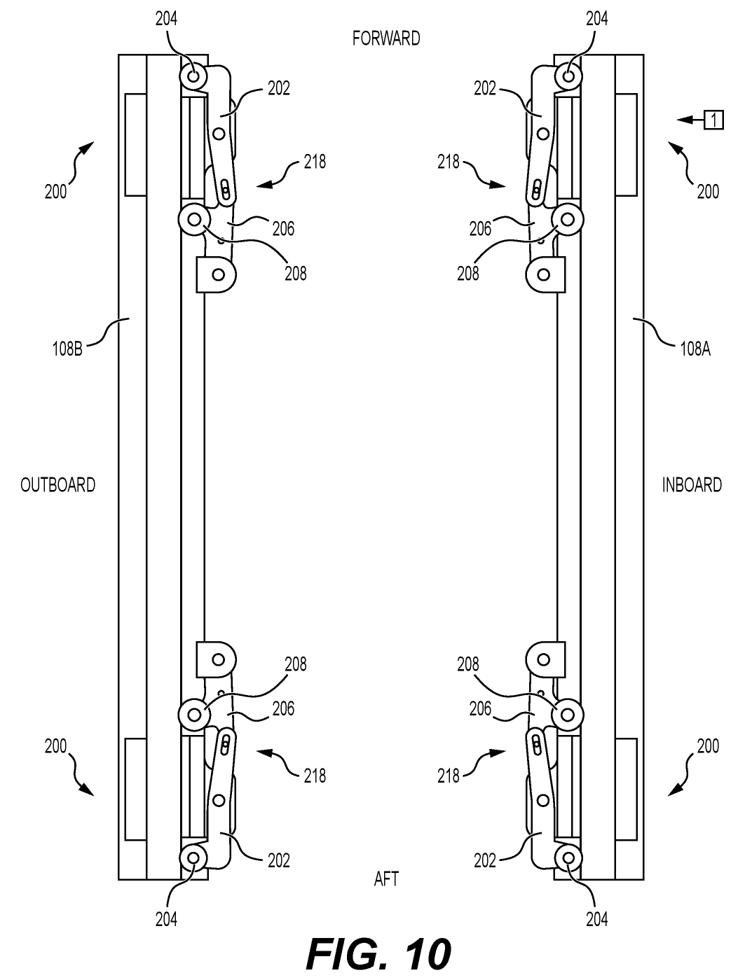

With reference to FIG. 10, the aircraft seat carriage 100 is misaligned with the tracking rails 108A and 108B. In the embodiment shown in FIG. 10, the aircraft seat carriage 100 is not centered between the rails 108A/108B such that the carriage is too close to each of rails 108A/108B. In embodiments, when the carriage 100 and tracking rails 108A/108B are misaligned, as shown in FIG. 10, the aircraft seat carriage 100 is either too close or too far from the tracking rails 108A/108B on forward, aft, inboard, and outboard sides. More specifically, referring to the misalignment shown in FIG. 10, the aircraft seat carriage 100 is too close to the outboard rail 108B and the inboard rail 108A. In embodiments, the alignment system 200 substantially responds to misalignment between the rails 108A/108B and carriage 100 and prevents the carriage from contacting either of the rails. Again, with reference to FIG. 10, when the carriage 100 is too close to outboard rail 108B, the rail presses against the alignment roller 208 and causes the rail alignment arm 206 to adjust the tension in the spring 210. This causes the rail indexing arm 202 to bias the indexing roller 204 towards the tracking rail 108 and may linearly align the indexing roller 204 and alignment roller 208. When the carriage 100 is too far from the inboard rail 108A (see the inboard rail 108A of FIG. 9), the indexing roller 204 maintains alignment against the rail 108A/108B. This allows the spring 210 to bias the rail alignment arm 206 and alignment roller 208 away from the tracking rail 108 such that the alignment roller 208 is spaced away from the rail. In this way the indexing roller 204 may substantially maintain contact with the tracking rail edge of tracking rail 108. In embodiments, the alignment between the aircraft seat carriage 100 and the tracking rails 108A/108B acts as an input for whether or not the alignment roller 208 is pressed against or spaced away from a respective rail. This substantially may prevent the aircraft seat carriage 100 from colliding with the tracking rail 108. This is advantageous because the aircraft seat carriage 100 may track more smoothly on the tracking rails 108A/108B and may allow for seat movement along the tracking rails 108A/108B when there is misalignment between the aircraft seat carriage 100 and the rails 108A/108B.

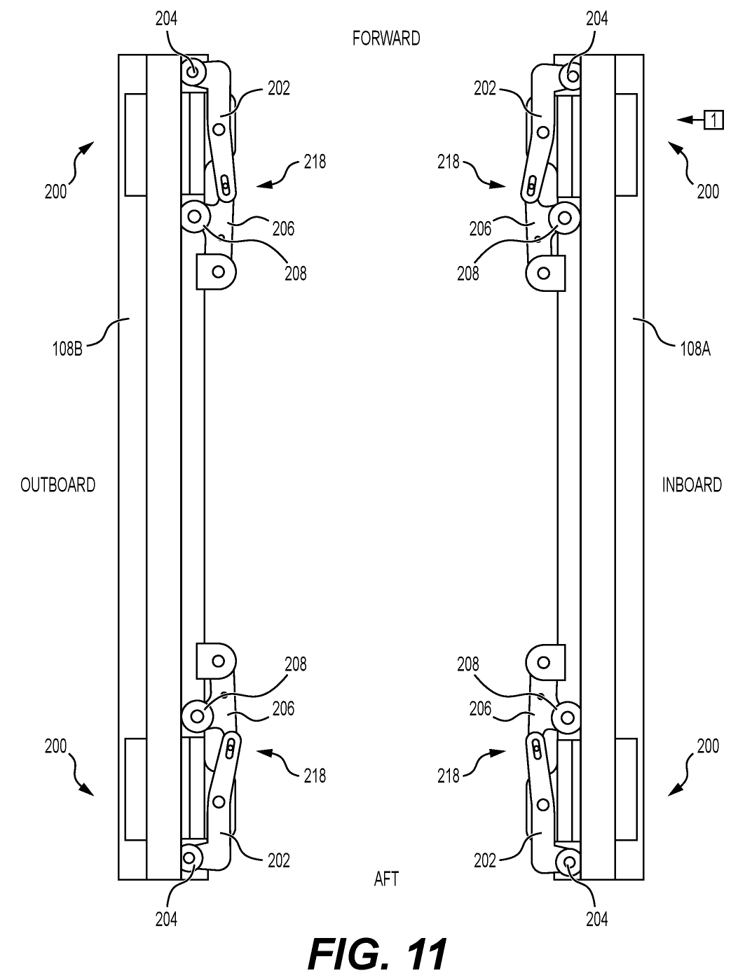

With reference to FIG. 11, the aircraft seat carriage 100 is misaligned with the tracking rails 108A and 108B. In the embodiment shown in FIG. 11, the aircraft seat carriage 100 and the tracking rails 108A/108B are not parallel with one another, which results in a misaligned orientation. In embodiments, when the carriage 100 and inboard tracking rail 108A/108B are misaligned, as shown in FIG. 11, the aircraft seat carriage 100 is either too close or too far from the tracking rails 108A/108B on forward, aft, inboard, and outboard sides. More specifically, referring to the misalignment shown in FIG. 11, the aircraft seat carriage 100 is too close to the outboard rail 108B at a forward end of the rail and too close to the inboard rail 108A at an aft end of the rail. Shown in FIG. 11, the aircraft seat carriage 100 is too far from the outboard rail 108B at an aft end of the rail and too far from the inboard rail 108A at a forward end of the rail. In embodiments, the alignment system 200 substantially responds to misalignment between the rails 108A/108B and carriage 100 and prevents the carriage from contacting either of the rails. Again, with reference to FIG. 11, when the carriage 100 is too close to either of rails 108A or 108B (e.g., at the forward portion of rail 108B and the aft portion of rail 108A), the rail presses against the indexing roller 204 and causes the rail indexing arm 202 to adjust the tension in the spring 210. This causes the rail alignment arm 206 to bias the alignment roller 208 towards the tracking rail 108 and may linearly align the indexing roller 204 and alignment roller 208. When the carriage 100 is too far from either of rail 108A or 108B (e.g., at the forward portion of 108A and the aft portion of 108B), the indexing roller 204 maintains alignment against the rail 108A/108B. This allows the spring 210 to bias the rail alignment arm 206 and alignment roller 208 away from the tracking rail 108 such that the alignment roller 208 is spaced away from the rail. In this way the indexing roller 204 may substantially maintain contact with the tracing rail edge of tracking rail 108. In embodiments, the alignment between the aircraft seat carriage 100 and the tracking rails 108A/108B acts as an input for whether or not the alignment roller 208 is pressed against or spaced away from a respective rail. This substantially may prevent the aircraft seat carriage 100 from colliding with the tracking rail 108. This is advantageous because the aircraft seat carriage 100 may track more smoothly on the tracking rails 108A/108B and may allow for seat movement along the tracking rails 108A/108B when there is misalignment between the aircraft seat carriage 100 and the rails 108A/108B.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed is:

1. A carriage alignment system for an aircraft seat comprising:
a rail indexing arm having an indexing roller operatively coupled to a tracking rail;
a rail alignment arm having an alignment roller operatively coupled to the tracking rail and mechanically coupled to the rail indexing arm, wherein the rail indexing arm and the alignment arm are operatively coupled to an aircraft seat carriage; and
a spring operatively coupled to the rail alignment arm, such that the spring biases the indexing roller towards the tracking rail and biases the alignment roller away from the tracking rail.

2. The alignment system of claim 1, wherein the spring is disposed at a pivot point which mechanically couples the rail indexing arm and the rail alignment arm.

3. The alignment system of claim 1, wherein the tracking rail is an I-beam comprising an I-shape.

4. The alignment system of claim 1, wherein the indexing roller and the alignment roller each comprise a convex shape configured to allow edges of the rollers to extend over upper and lower edges of the tracking rail.

5. The alignment system of claim 1, wherein the indexing roller and the alignment roller are configured to roll against a tracking rail edge of the tracking rail adjacent to the alignment system.

6. The alignment system of claim 1, wherein the tracking rail comprises a plurality of holes disposed along the length of a top surface of the tracking rail, wherein the holes are each configured to receive a locking pin which locks the carriage into a tracked position corresponding to a location of a respective one of the holes.

7. The alignment system of claim 1, wherein the spring causes the indexing roller to be biased towards the tracking rail when the aircraft seat carriage is substantially aligned with the tracking rail.

8. The alignment system of claim 2, wherein the alignment roller is mounted at an opposite side of the pivot point than the indexing roller such that pivoting at the pivot point causes the indexing arm to bias the alignment arm towards or away from the tracking rail.

9. The alignment system of claim 1, wherein when the aircraft seat carriage is too close to the tracking rail, the tracking rail presses against the indexing roller which causes the rail indexing arm and the rail alignment arm to rotate and bias the alignment roller towards the tracking rail.

10. The alignment system of claim 1, wherein when the aircraft seat carriage is too far from the tracking rail, the tracking rail is spaced away from the alignment roller which causes the spring to bias the indexing roller towards the tracking rail.

11. The alignment system of claim 1, wherein rolling the indexing roller and the alignment roller against the tracking rail causes movement of the aircraft seat carriage along the tracking rail.

12. A system for aligning an aircraft seat comprising:
at least one pair of alignment subsystems, the subsystems comprising:
an indexing roller rotatably mounted to an indexing arm, and
an alignment roller rotatably mounted to an alignment arm;
wherein the indexing roller and the alignment roller are configured to roll along one of a pair of tracking rails disposed within an aircraft cabin, and the indexing arm and the alignment arm are pivotally coupled together;
a spring operatively coupled to the rail alignment arm such that the spring biases the indexing roller towards one of the pair of tracking rails adjacent to the alignment subsystem and biases the alignment roller away from one of the pair of tracking rails adjacent to the alignment subsystem;
wherein the spring is configured to adjust when one of the pair of tracking rails presses against the indexing roller causing the alignment roller to bias further towards one of the pair of tracking rails.

13. The system of claim 12, wherein one of the pair of alignment subsystems is disposed at a forward portion of an aircraft seat carriage and one of the pair of alignment subsystems is disposed at an aft portion of the aircraft seat carriage such that the aircraft seat carriage may be aligned with the pair of tracking rails at its forward and aft ends.

14. The system of claim 13, wherein when the aircraft seat carriage and the pair of tracking rails are misaligned, one of the pair of tracking rails presses against at least one indexing roller, which causes the rail indexing arm to rotate, which causes the alignment arm to bias the alignment roller towards the tracking rail.

15. The system of claim 13, wherein when the aircraft seat carriage and the pair of tracking rails are misaligned, one of the pair of tracking rails is spaced away from at least one alignment roller, which causes the spring to bias the indexing arm and causes the indexing roller to move towards the tracking rail.

16. The system of claim 12, wherein the indexing roller is rotatably mounted within a roller housing which forms an end of the indexing arm.

17. The system of claim 12, wherein the spring is coupled to the rail alignment arm at the position where the indexing arm and the alignment arm are coupled together.

18. The system of claim 12, wherein the indexing arm is pivotally mounted to aircraft seat structure and is configured to pivot within a groove of the aircraft seat structure.

19. The system of claim 12, wherein the indexing roller and the alignment roller have a convex shape which allows for upper and lower edges of the rollers to extend over an edge of the tracking rail and substantially keeps the rollers engaged with the edge of the tracking rail.

20. The system of claim 12, wherein the tracking rail is an I-beam and the indexing roller and the alignment roller roll along a tracking rail edge of the I-beam.
